(19) United States
(12) Patent Application Publication
(10) Pub. No.: US 2006/0070700 A1
(43) Pub. Date: Apr. 6, 2006

(54) System for automated label activation and application

(75) Inventor: William Cone, Weeki Wachee, FL (US)

Correspondence Address: LAHIVE & COCKFIELD, LLP., 28 STATE STREET, BOSTON, MA, 02109, US

(73) Assignee: Pro-Motion Industries, L.L.C., Hammonton, NJ (US)

(21) Appl. No.: 11/236,277

(22) Filed: Sep. 26, 2005

Related U.S. Application Data
(60) Provisional application No. 60/615,279, filed on Oct. 1, 2004.

(51) Int. Cl. B65C 9/18; B32B 37/00; B32B 38/10

(52) U.S. Cl. 156/249; 156/542

(57) ABSTRACT

A label activation and application system and method includes a label preparation mechanism for preparing a first label. A feeder supplies a second label. A combiner mechanism combines the first label with the second label to form a combined label. An applicator applies the combined label to a targeted location, if desired. The method results in the formation of a combined label supporting a chemical reaction either upon formation or upon a further activation step. The chemical reaction can serve as an indicator of subsequent exposure of the label to such variables as time, temperature, light, oxidation, and the like.

### RELATED APPLICATIONS

This application claims priority to, and the benefit of, co-pending U.S. Provisional Application No. 60/615,279, filed Oct. 1, 2004, for all subject matter common to both applications. The disclosure of said provisional application is hereby incorporated by reference in its entirety.

### FIELD OF THE INVENTION

The present invention relates to a system and method for the activation and application of labels, and more particularly to the preparation and activation application of multi-part labels that can indicate elapsed time and/or temperature variations from a point of activation.

### BACKGROUND OF THE INVENTION

There are a number of different conventional labeling systems for applying gummed or adhesive-backed labels to packaging or other desired locations. The conventional labeling systems are designed to operate with conventional labels.

Typically, conventional labels have an adhesive backing and they are formed on a continuous carrier strip often bundled around a reel. The conventional labeling device for mass application of labels consists of a machine supporting a supply of adhesive backed labels that applies the labels while feeding the carrier strip from the supply reel to a take-up reel. The system typically includes a means for applying the labels to a desired location on the package or product, using a device to remove the label from the carrier. As the labels are transferred from the carrier strip to the desired location, the carrier strip continues on, to be collected at the take-up reel.

Conventional label application systems apply a label to a location, and then move on to another location for subsequent label application. This can be done either by moving the label application mechanism, or by moving the location, such as by moving a series of packages along a conveyor belt through, over, or under the label applicator system.

Some label application systems are also configured to place labels onto other labels. This placement can be completed while one label is still on the carrier strip or after it is already applied to a package or location. The application of labels over pre-existing labels may be required to correct incorrect information on the pre-existing label, to place additional information on a package, or to update the label. In instances where the label is applied to a label on a carrier strip, the combined labels are then re-rolled for later application. Additional uses of multiple label applications include to add a security feature, to add a tracking device, to add a scratch-off covering, or to place a clear protection layer over a label.

However, none of the above label application methods or systems referred to are configured to combine two labels for purposes of activating a response or action and then automatically apply the combined label to the desired location, or present them for a user to apply to a desired location.

### SUMMARY

There is a need for a system and method to combine two labels for purposes of activating a response or action and then automatically apply the combined label to the desired location, or present them for a user to apply to a desired location. The present invention is directed toward further solutions to address this need.

In accordance with one embodiment of the present invention, a label activation and application system includes a label preparation mechanism for preparing a first label. A feeder supplies a second label. A combiner mechanism combines the first label with the second label to form a combined label. An applicator applies the combined label to a targeted location, if desired.

In accordance with aspects of the present invention, the label preparation mechanism is configured to remove the first label from a carrier strip. In addition, the combiner mechanism can be one of a merger device, a stamping applicator, or an applicator wheel. Furthermore, combing the first label with the second label can either activate a chemical process or enable activation of a chemical process.

In accordance with one embodiment of the present invention, a label activation system includes a label preparation mechanism for preparing a first label. A feeder supplies a second label. A combiner mechanism combines the first label with the second label to form a combined label. Combination of the first label with the second label can activate a chemical reaction within the combined label or enable activation of a chemical reaction within the combined label.

In accordance with aspects of the present invention, the activation of the chemical reaction occurs upon the combination of the first label with the second label. Alternatively, the activation of the chemical reaction occurs subsequent to an additional activator action. The additional activator action can include the application of at least one of heat, light, chemical, and time to activate the chemical reaction.

In accordance with further aspects of the present invention, wherein the label preparation mechanism can be configured to remove the first label from a carrier strip. The combiner mechanism can be one of a merger device, a stamping applicator, or an applicator wheel.

In accordance with one embodiment of the present invention, a method of applying a label includes preparing a first label for adhesion to a second label using a label preparation mechanism. A second label is supplied with a feeder. The first label is applied to the second label using a combiner mechanism to form a combined label. The combined label can then be applied to a targeted location.

In accordance with further aspects of the method of the present invention, applying the first label to the second label can initiate a chemical reaction. Applying the first label to the second label can likewise enable a chemical reaction to occur.

In accordance with further aspects of the method of the present invention, the method can further include applying a third label to the combined label.

In accordance with further aspects of the method of the present invention, preparing a first label for adhesion can include the preparation mechanism removing the first label from a carrier strip. Applying the first label to the second label using a combiner mechanism can include utilizing one of a merger device, a stamping applicator, or an applicator wheel to mechanistically apply the first label.

In accordance with one embodiment of the present invention, a method of activating a chemical reaction within a label includes preparing a first label for adhesion to a second label using a preparation mechanism. The second label is provided using a feeder. The first label is adhered to the second label using a combiner mechanism to form a combined label. Adhering the first label to the second label can enable activation of a chemical reaction within the combined label.

In accordance with aspects of the method of the present invention, the chemical reaction initiates after formation of the combined label, or is activated after forming the combined label. A third label can be applied to the combined label. Preparing a first label for adhesion can include the preparation mechanism removing the first label from a carrier strip. Furthermore, applying the first label to the second label using a combiner mechanism can include utilizing one of a merger device, a stamping applicator, or an applicator wheel to mechanistically apply the first label.

### BRIEF DESCRIPTION OF THE DRAWINGS

The present invention will become better understood with reference to the following description and accompanying drawings, wherein:

FIGS. 1A and 1B are side and top views of a combined label, according to one aspect of the present invention;

FIG. 2 is a diagrammatic illustration of a label application/activation system, according to one embodiment of the present invention;

FIG. 3 is a flowchart illustrating a method of activating and applying a combined label, according to one aspect of the present invention;

FIGS. 4A and 4B are diagrammatic illustrations of label application/activation system embodiments, according to aspects of the present invention; and

FIG. 5 is a diagrammatic illustration of a label application/activation system, according to one embodiment of the present invention.

### DETAILED DESCRIPTION

An illustrative embodiment of the present invention relates to a system and method for the combination of multiple labels, to initiate a chemical action and form a combined label, and the subsequent application of the combined label at a targeted location. The combined label can be configured to indicate changes in such variables as elapsed time, and temperature fluctuation, over a period of time from the point of activation. The combined label can be automatically activated by the system and method for applying the labels as described herein, in accordance with the present invention.

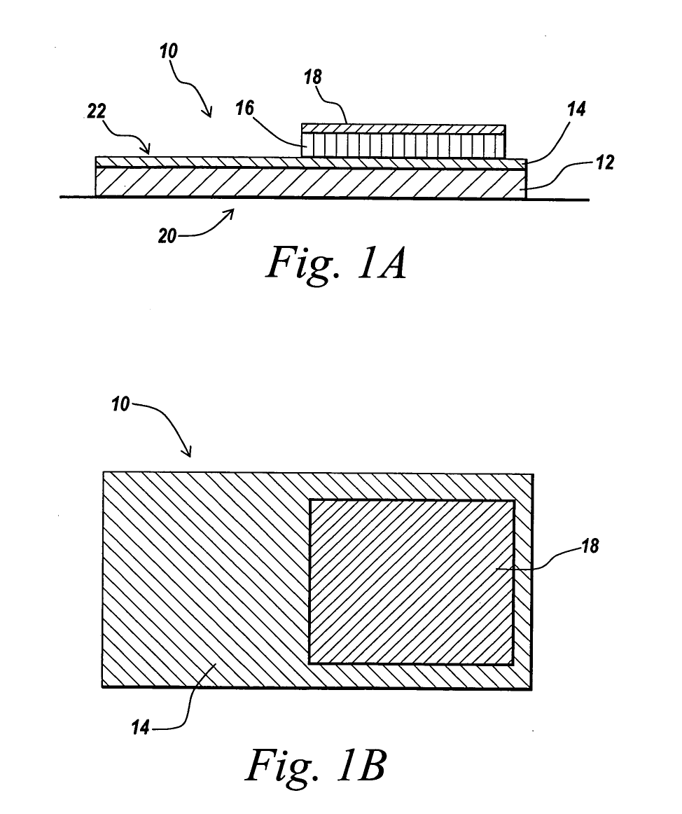

FIGS. 1A through 5, wherein like parts are designated by like reference numerals throughout, illustrate an example embodiment of a label activation/application system and method according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

The present invention involves a system and method for preparing a combined label 10, an example of which is shown in FIGS. 1A and 1B, for application to a targeted location. The combined label 10 is formed of a plurality of layers, some of which contain agents that are affected by the combination of the layers to form the combined label 10.

In accordance with one example embodiment of the combined label 10, the combined label 10 is formed of a base adhesive layer 12, a base label 14, an adhesive/activation layer 16 and a surface label 18. It should be noted that the combined label 10 is not limited to the specific embodiment described and illustrated. Rather, the combined label 10 can have additional layers, or configurations, as understood by one of ordinary skill in the art.

Returning to the example, the base adhesive layer 12 can contain a conventional form of adhesive for applying the combined label 10 to a target location 20. The adhesive layer 12 adheres to the base label 14. The base label 14 can have a number of different configurations, and be formed of a number of different materials. For example, the base label 14 can have a standard geometric shape, or can be irregular in shape. The base label 14 can be sized and dimensioned to fit within a predetermined area at the targeted location 20. The base label 14 can be made of natural or synthetic materials, including but not limited to paper, plastic, composite, textile, mesh, and the like. In addition, the base adhesive layer 12 can cover the entirety of the base label 14 area, or can cover portions or sections of the base label 14.

The base label 14 can further include a base component or coating either mixed into the base label 14, or provided on a surface 22 of the base label 14. The base component or coating is an agent that reacts to predetermined conditions. The predetermined conditions can include physical properties, and/or the application or exposure of the agent to selected chemicals or other agents. The base component or coating can further include an adhesive component, if desired, to aid in adhering the base label 14 to the surface label 18, such as for example, in the instance of contact cement.

In the example embodiment, the adhesive/activation layer 16 includes an adhesive component as well as an activation component. The adhesive component and the activation component can be the same component, or can be different components. The adhesive component works to adhere the surface label 18 to the base label 14. The adhesive component can work in conjunction with the base component or coating, if it also contains an adhesive component, such as with contact cement. Alternatively, the adhesive component of the adhesive/activation layer 16 can merely be compatible with the base label 14 and any base component or coating, to the extent that the adhesive layer will adhere to the base label 14.

The adhesive/activation layer 16 also includes an activation component. In the example embodiments, the activation component, when combined or mixed with the base label 14 or the base component or coating, activates a chemical reaction. The chemical reaction can be designed to indicate changes in a number of different properties or variables. For example, the chemical reaction can indicate the passing of time from the point that the chemical reaction began. The chemical reaction can indicate a current temperature, a change in temperature, exposure to temperature outside of predetermined ranges, and/or temperature fluctuations. The time and temperature variables can both affect the chemical reaction together. For example, the combined label 10 can be affixed to a package of fish. The label can indicate the time elapsed since the label was created, activated, and placed on the packaging. The combined label 10 can also indicate a current fish temperature. Furthermore, the label can indicate whether at any time during the label's existence on the package of fish, the temperature has increased to, or beyond, a pre-determined level. The combined label 10 can further indicate a combination of time elapsed, and temperature conditions over a period of time. Thus, the combined label 10 can estimate the freshness of the fish in the packaging by indicating the amount of time the fish has been in the packaging, and the amount of spoilage that may have occurred based on temperature of the fish during its time in the packaging. Accordingly, in such an instance, it is necessary to activate the label and apply it to the packaging within a relatively short window of time to ensure its accuracy.

It should be noted that the chemical reaction can initiate upon the adhesion of the base label 14 and the surface label 18. Alternatively, the adhesion of the base label 14 and the surface label 18 can create a resultant chemical or mixture that can subsequently be activated, such as by heat, light, oxidation, or other activator activities, which can be incorporated into the system and method of the present invention as required.

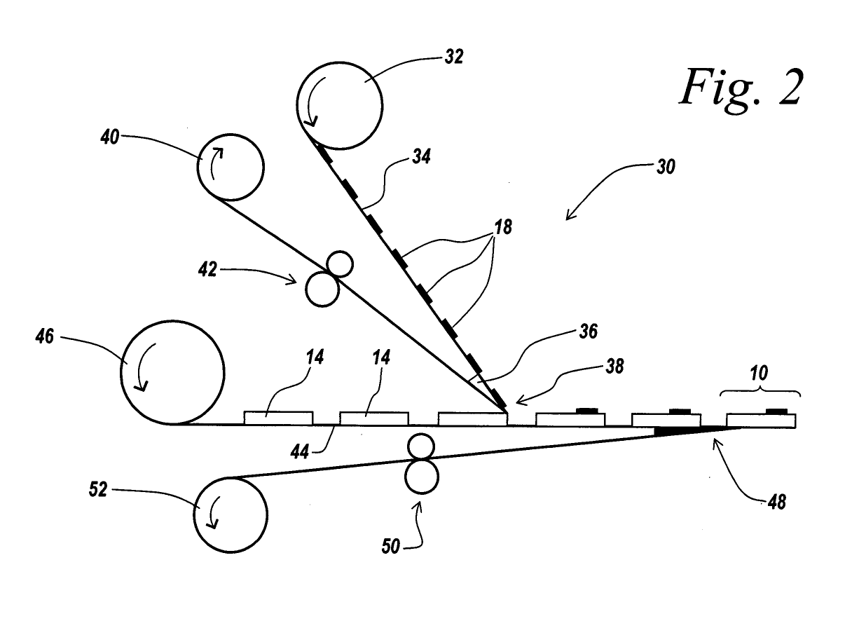

The present invention provides a system and method for creating and applying such a combined label 10, and other similar labels requiring similar preparation steps. A label activation/application system 30 is provided, an example of which is illustrated in FIG. 2. In accordance with one embodiment of the present invention, the label activation/application system 30 creates the combined label 10, and then places the combined label on the targeted location 20, such as the exemplar packaging for fish, or provides the combined label 10 for later or subsequent application. The label activation/application system 30 includes a supply reel 32 that holds a carrier strip 34 of surface labels 18. A peel-off plate 36 peels off a backing to the surface labels 18 revealing the adhesive/activation layer 16. A merger device 38 applies the surface labels 18 to the base labels 14. A rewind reel 40 collects the carrier strip 34 after the surface label 18 is removed, and is driven by a drive section 42.

A second carrier strip 44 supports the base labels 14, and is supplied by a second supply reel 46. A second peel-off plate 48 peels the base labels 14, and thus the combined labels 10 as formed, from the second carrier strip 44 for application to the targeted location 20, or to hand off for subsequent application by hand or by another device. A drive section 50 drives the second carrier strip 44, which is collected by a second rewind reel 52.

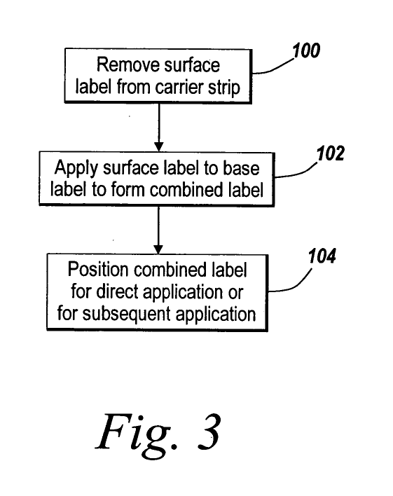

FIG. 3 is a flowchart illustrating one example embodiment of using the system of FIG. 2 to create and apply the combined label 10. The surface label 18 is fed through the peel-off plate 36 to remove the surface label 18 from the carrier strip 34 (step 100). The surface label 18 is then applied to the base label 14 to create the combined label 10 (step 102). After formation of the combined label 10, the combined label 10 is positioned for one of application to the targeted location and supply to a separate mechanism for application to the targeted location (step 104). The separate mechanism for application to the targeted location can be another system or device, or can alternatively be a user that takes the combined label 10 and places it on the targeted location by hand or using a tool.

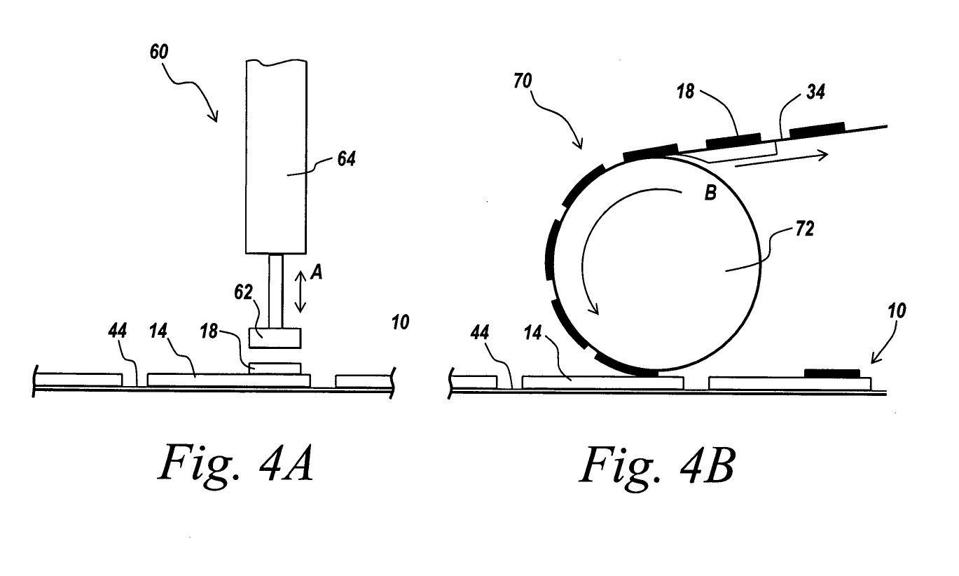

FIG. 4A illustrates an alternative embodiment of a label activation/application system 50. The alternative label activation/application system 60 includes a stamping applicator 62 powered by a powered cylinder 64. The powered cylinder moves the stamping applicator 62 in the direction of arrow A, placing the surface label 18 onto the base label 14 to form the combination label 10. The powered cylinder can be powered in a number of different ways, as understood by one of ordinary skill in the art, including but not limited to hydraulically, electrically, and mechanically. In operation, the carrier strip 44 moves the base label 14 into position under the label activation/application system 60. The stamping applicator 62 stamps the surface label 18 onto the base label 14 to form the combined label 10. The combined label 10 then continues along the carrier strip 44 for later removal and application to the targeted location.

A further alternative label activation/application system 70 is provided in FIG. 4B. The system includes an applicator wheel 72. The carrier strip 34 provides a feed of the surface labels 18 to the applicator wheel 72. The applicator wheel 72 rotates in the direction of arrow B and positions the surface label 18 onto the base label 14 to form the combined label 10. The carrier strip 44 then moves the combined label 10 for later removal and application to the targeted location.

In all example embodiments, the label activation/application system 30, 60, and 70 creates the combined label 10 just prior to the combined label 10 being applied to the targeted location 20 or being made available for such application. Depending on the specific embodiment of the combined label 10 as discussed previously, it may be more or less time sensitive regarding the combination of the layers and the application to the packaging or targeted location. Accordingly, the specific embodiment of the label activation/application system 30, 60, and 70 can be configured to accommodate such requirements.

Whether the label activation/application system 30, 60, and 70 applies the combined label 10 directly to the targeted location, or provides the combined label 10 for subsequent application, there are a number of different methods and devices that can be used to apply the combined label 10 to the targeted location. Such different methods include but are not limited to blowing on the label, wiping on the label, rolling on the label, tamping the label, using a swing arm to move the label to the targeted location, swiping the label, using an air wand, vacuum transfer and/or application of the label, mechanical application, by user hand, using a tool, and any combination of the above.

Furthermore, it should be noted that in some embodiments of the combined label 10, the formation of the combined label 10 by hand may contaminate the chemicals located on the surface 22 of the base label, or in the adhesive/activation layer 16, which can alter the accuracy of the combined label 10. In addition, placing the separate label layers together by hand can heat the labels, causing problems with some chemicals, and possibly inadvertently activating the combined label 10 before a desired activation time. Furthermore, alignment of the multiple label layers with each other can be crucial to the subsequent effectiveness of the combined label 10. The pressure applied during the formation of the combined label 10 in some embodiments must be consistent and within predetermined ranges to ensure good activation and accurate implementation. Accordingly, using multiple different devices to form such a combined label can have drawbacks addressed by the use of the present invention. Thus, the automated formation of the combined label 10 is crucial to its successful implementation for many embodiments of the combined label 10.

It should further be noted that the combined label 10 as illustrated is shown having two label layers and two adhesive layers. However, one of ordinary skill in the art will appreciate that the combined label 10 can have multiple layers in addition to those illustrated. Accordingly, with each successive layer, an additional step of providing a carrier strip with a label layer and aligning and applying that label layer to another label layer is required. Thus, the label activation/application system 30, 60, and 70 and corresponding method of the present invention anticipate the formation of combined labels having a number of layers different from that illustrated. Accordingly, the label activation/application system 30, 60, and 70 is configured accordingly for each additional layer required to form the combined label prior to application of the combined label to the targeted location.

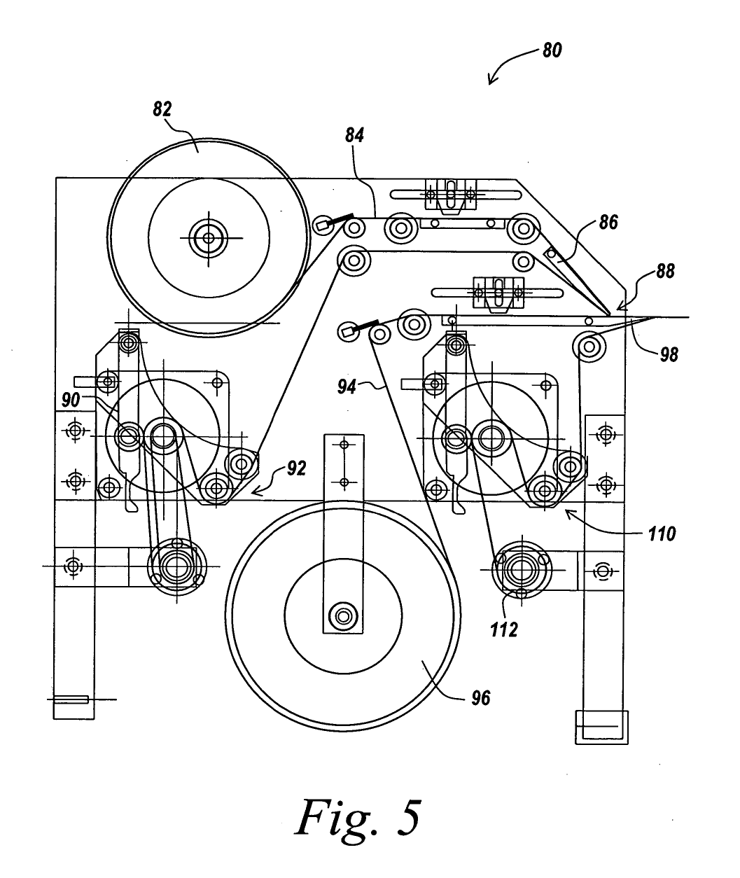

FIG. 5 shows a layout for another embodiment of label activation/application system 80 in accordance with the present invention. The basic process for formation of the combined label as described herein in the other embodiments applies to this label activation/application system 80 as well. In accordance with this embodiment of the present invention, the label activation/application system 80 creates the combined label with a slightly different configuration. The label activation/application system 80 includes a supply reel 82 that holds a carrier strip 84 of surface labels. A peel-off plate 86 peels off a backing to the surface labels revealing the adhesive/activation layer. A merger device 88 applies the surface labels to the base labels. A rewind reel 90 collects the carrier strip after the surface label is removed, and is driven by a drive section 92.

A second carrier strip 94 supports the base labels, and is supplied by a second supply reel 96. A second peel-off plate 98 peels the base labels, and thus the combined labels as formed, from the second carrier strip for application to the targeted location, or to hand off for subsequent application by hand or by another device. A drive section 110 drives the second carrier strip, which is collected by a second rewind reel 112.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the disclosed invention is reserved.

What is claimed is:

1. A label activation and application system, comprising:
a label preparation mechanism for preparing a first label;
a feeder for supplying a second label;
a combiner mechanism for combining the first label with the second label to form a combined label; and
an applicator for applying the combined label to a targeted location.

2. The label activation and application system of claim 1, wherein the label preparation mechanism is configured to remove the first label from a carrier strip.

3. The label activation and application system of claim 1, wherein the combiner mechanism comprises one of a merger device, a stamping applicator, or an applicator wheel.

4. The label activation and application system of claim 1, wherein combing the first label with the second label one of activates a chemical process or enables activation of a chemical process.

5. A label activation system, comprising:
a label preparation mechanism for preparing a first label;
a feeder for supplying a second label; and
a combiner mechanism for combining the first label with the second label to form a combined label;
wherein combination of the first label with the second label one of activates a chemical reaction within the combined label or enables activation of a chemical reaction within the combined label.

6. The label activation system of claim 5, wherein the activation of the chemical reaction occurs upon the combination of the first label with the second label.

7. The label activation system of claim 5, wherein the activation of the chemical reaction occurs subsequent to an additional activator action.

8. The label activation system of claim 7, wherein the additional activator action comprises the application of at least one of heat, light, chemical, and time to activate the chemical reaction.

9. The label activation system of claim 5, wherein the label preparation mechanism is configured to remove the first label from a carrier strip.

10. The label activation system of claim 5, wherein the combiner mechanism comprises one of a merger device, a stamping applicator, or an applicator wheel.

11. A method of applying a label, comprising:
preparing a first label for adhesion to a second label using a label preparation mechanism;
supplying a second label with a feeder;
applying the first label to the second label using a combiner mechanism to form a combined label; and
applying the combined label to a targeted location.

12. The method of claim 11, wherein applying the first label to the second label initiates a chemical reaction.

13. The method of claim 11, wherein applying the first label to the second label enables a chemical reaction to occur.

14. The method of claim 11, further comprising activating the chemical reaction.

15. The method of claim 11, further comprising applying a third label to the combined label.

16. The method of claim 11, wherein preparing a first label for adhesion comprises the preparation mechanism removing the first label from a carrier strip.

17. The method of claim 11, wherein applying the first label to the second label using a combiner mechanism comprises utilizing one of a merger device, a stamping applicator, or an applicator wheel to mechanistically apply the first label.

18. A method of activating a chemical reaction within a label, comprising:
preparing a first label for adhesion to a second label using a preparation mechanism;
providing the second label using a feeder; and
adhering the first label to the second label using a combiner mechanism to form a combined label;
wherein adhering the first label to the second label enables activation of a chemical reaction within the combined label.

19. The method of claim 18, wherein the chemical reaction initiates after formation of the combined label.

20. The method of claim 18, further comprising activating the chemical reaction enabled by the combined label.

21. The method of claim 18, further comprising applying a third label to the combined label.

22. The method of claim 18, wherein preparing a first label for adhesion comprises the preparation mechanism removing the first label from a carrier strip.

23. The method of claim 18, wherein applying the first label to the second label using a combiner mechanism comprises utilizing one of a merger device, a stamping applicator, or an applicator wheel to mechanistically apply the first label.
